(19) United States
(12) Patent Application Publication
(10) Pub. No.: US 2012/0134045 A1
(43) Pub. Date: May 31, 2012

(54) MAGNETIC HEAD AND DISK DRIVE WITH THE SAME

(75) Inventor: Takashi Toyoguchi, Zama-shi (JP)

(73) Assignee: KABUSHIKI KAISHA TOSHIBA, Tokyo (JP)

(21) Appl. No.: 13/245,634

(22) Filed: Sep. 26, 2011

(30) Foreign Application Priority Data
Nov. 30, 2010 (JP) 2010-266712

(51) Int. Cl. G11B 5/60; G11B 17/34

(52) U.S. Cl. 360/97.12; 360/234.3; G9B/5.229; G9B/17.062

(57) ABSTRACT

According to one embodiment, a magnetic head of a disk drive includes a head slider including a disk-facing surface, and an inflow end surface and an outflow end surface extending across the disk-facing surface, a write element and a read element in an end portion of the head slider on the side of the outflow end surface, and an SiNx film formed on the outflow end surface of the head slider.

### CROSS-REFERENCE TO RELATED APPLICATIONS

This application is based upon and claims the benefit of priority from Japanese Patent Application No. 2010-266712, filed Nov. 30, 2010; the entire contents of which are incorporated herein by reference.

### FIELD

Embodiments described herein relate generally to a magnetic head used in a disk drive and the disk drive provided with the magnetic head.

### BACKGROUND

A disk drive, such as a magnetic disk drive, comprises a magnetic disk for use as a recording medium, spindle motor, magnetic head, and carriage assembly. The magnetic disk is disposed in a case. The spindle motor supports and rotates the disk. The magnetic head reads data from and writes data to the disk. The carriage assembly supports the head for movement relative to the disk. The head comprises a slider mounted on a suspension of the carriage assembly and a head section disposed on the slider. The head section comprises read and write heads. The magnetic head, which comprises the read/write (R/W) elements, is caused to fly above the fast-rotating disk by airflow as it reads or writes data.

To meet the recent demand for higher recording density, it is regarded as important to reduce the head flying height and control the flying head in a very low-flying hight. Thus, techniques for dynamically controlling the head flying height have been rapidly increasing. Presently, the flying gap between the slider and magnetic disk near the R/W elements of the magnetic head is set to 10 nm or less. Further, the gap between the R/W elements and medium is approximated to several nm by combining this technique the dynamic flying height controle (DFH) technique for controlling the magnetic spacing by dynamically causing the R/W elements to project.

Consequently, a lubricant applied to the disk surface is transferred to the flying surface of the head slider flying above the magnetic disk. Thus, problems have become obvious such that the magnetic spacing is enlarged, the flying state of the slider is unstable, etc.

The lubricant transferred to the flying surface of the slider of the magnetic head is moved to an outflow end surface of the head slider by airflow and accumulates on it. If the accumulation of the transferred lubricant becomes excessive, the lubricant drops from the head slider onto the medium during a seek operation of the magnetic head. In this case, the dropped lubricant contacts the R/W element section of the slider at its drop point, thereby making the flying height of the slider unstable. Thereupon, a problem (high fly write or HFW) occurs that read or write signals become unstable. Further, a magnetic spacing loss occurs as the lubricant diffuses and returns to the R/W element section on the flying-surface side with the magnetic head unloaded while the magnetic disk drive is off. Thus, the read/write properties vary such that the read/write performance is reduced when the disk drive is started and is then gradually recovered with the passage of time.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an HDD according to a first embodiment;

FIG. 2 is an exemplary side view showing a magnetic head and suspension of the HDD;

FIG. 3 is an exemplary perspective view of a head slider of the magnetic head taken from its ABS side;

FIG. 4 is an exemplary front view of the magnetic head;

FIG. 5 is an exemplary enlarged side view showing the magnetic head and suspension;

FIG. 6 is an exemplary diagram comparatively showing the respective lubricant bond strengths (bonding ratios) of an SiNx film and another film nitrogenated DLC film);

FIG. 7 is an exemplary diagram showing the relationship between the respective thicknesses of the SiNx film and a lubricant coating film;

FIG. 8 is an exemplary diagram showing the relationship between the lubricant film thickness and the nitrogen-to-silicon ratio of SiNx film between the intensity of Nls and Si2p peaks based on the X-ray photoelectron spectroscopy (XPS);

FIG. 9 is an exemplary front view showing a magnetic head of an HDD according to a second embodiment;

FIG. 10 is an exemplary side view showing the magnetic head and a recording medium according to the second embodiment;

FIG. 11 is an exemplary front view showing a magnetic head of an HDD according to a third embodiment; and

FIG. 12 is an exemplary side view showing the magnetic head and a recording medium according to the third embodiment.

### DETAILED DESCRIPTION

Various embodiments will be described hereinafter with reference to the accompanying drawings.

In general, according to one embodiment, a magnetic head comprises: a head slider comprising a disk-facing surface, and an inflow end surface and an outflow end surface extending across the disk-facing surface; read/write elements in an end portion of the head slider on the side of the outflow end surface; and an SiNx film on the outflow end surface.

Embodiments in which disk drives are applied to hard disk drives (HDDs) will now be described in detail.

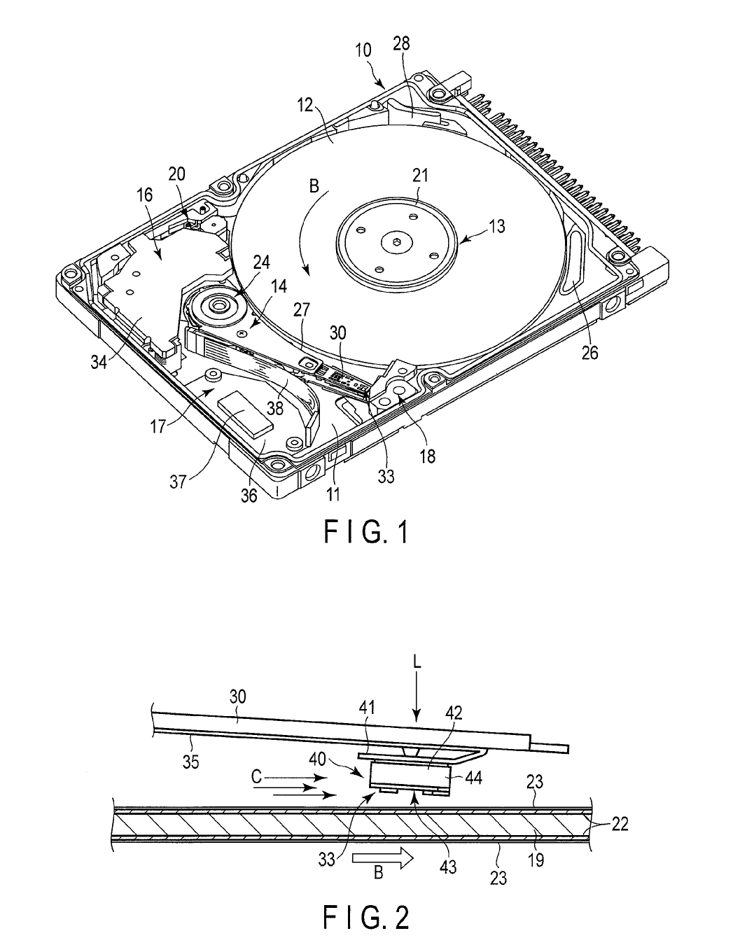

FIG. 1 shows the internal structure of an HDD according to a first embodiment, and FIG. 2 shows a flying magnetic head. As shown in FIG. 1, the HDD comprises a housing 10. The housing 10 comprises a base 11 in the form of an open-topped rectangular box and a top cover (not shown) in the form of a rectangular plate. The top cover is attached to the base by screws such that it closes the top opening of the base. Thus, the housing 10 is kept airtight inside and can communicate with the outside through a breather filter 26.

The base 11 carries thereon a magnetic disk 12, for use as a recording medium, and a mechanical unit. The mechanical unit comprises a spindle motor 13, a plurality (e.g., two) of magnetic heads 33, a head actuator 14, and voice coil motor (VCM) 16. The spindle motor 13 supports and rotates the magnetic disk 12. The magnetic heads 33 read data from and write data on the disk 12. The head actuator 14 supports the heads 33 for movement relative to the surfaces of the disk 12. The VCM 16 pivots and positions the head actuator. The base 11 further carries a ramp loading mechanism 18, inertia latch 20, and board unit 17. The ramp loading mechanism 18 holds the magnetic heads 33 in a position off the magnetic disk when the heads are moved to the outermost periphery of the disk. The inertia latch 20 holds the head actuator 14 in a retracted position if the HDD is jolted, for example. Electronic components, such as a preamplifier, head IC, etc., are mounted on the board unit 17.

A control circuit board (not shown) is attached to the outer surface of a bottom wall of the base 11 by screws. The circuit board controls the operations of the spindle motor 13, VCM 16, and magnetic heads 33 through the board unit 17.

As shown in FIGS. 1 and 2, the magnetic disk 12 is constructed as a double-layered perpendicular medium. The disk 12 comprises a substrate 19 formed of a nonmagnetic disk with a diameter of, for example, about 2.5 inches. A magnetic recording layer 22 is formed on each surface of the substrate 19. A protective film (not shown) is formed on the recording layer 22, and a lubricant 23 is applied to the uppermost layer.

As shown in FIG. 1, the magnetic disk 12 is coaxially mounted on the hub of the spindle motor 13 and clamped and secured to the hub by a clamp spring 21, which is attached to the upper end of the hub by screws. The disk 12 is rotated at a predetermined speed in the direction of arrow B by the spindle motor 13 for use as a drive motor.

The head actuator 14 comprises a bearing 24 secured to the bottom wall of the base 11 and a plurality of arms 27 extending from the bearing. The arms 27 are arranged parallel to the surfaces of the magnetic disk 12 and at predetermined intervals and extend in the same direction from the bearing 24. The head actuator 14 comprises elastically deformable suspensions 30 each in the form of an elongated plate. Each suspension 30 has its proximal end secured to the distal end of its corresponding arm 27 by spot welding or adhesive bonding and extends from the arm.

As shown in FIG. 2, each magnetic head 33 comprises a substantially cuboid head slider 42 and read/write head section 44 included in an outflow end portion of the slider. Each head 33 is secured to a gimbal spring 41 on the distal end portion of each corresponding suspension 30. A head load L directed to the surface of the magnetic disk 12 is applied to each head 33 by the elasticity of the suspension 30. The two arms 27 are arranged parallel to and spaced apart from each other, and the suspensions 30 and heads 33 mounted on these arms face one another with the magnetic disk 12 between them.

Each magnetic head 33 is electrically connected to a main FPC 38 (described later) through a relay flexible printed circuit (FPC) board 35 secured to the suspension 30 and arm 27.

As shown in FIG. 1, the board unit 17 comprises an FPC main body 36 formed of a flexible printed circuit board and the main FPC 38 extending from the FPC main body. The FPC main body 36 is secured to the bottom surface of the base 11. The electronic components, including a preamplifier 37 and head IC, are mounted on the FPC main body 36. An extended end of the main FPC 38 is connected to the head actuator 14 and also connected to each magnetic head 33 through each relay FPC 35.

The VCM 16 comprises a support frame (not shown) extending from the bearing 24 in the direction opposite to the arms 27 and a voice coil supported on the support frame. When the head actuator 14 is assembled to the base 11, the voice coil is located between a pair of yokes 34 that are secured to the base 11. Thus, the voice coil, along with the yokes and a magnet secured to the yokes, constitutes the VCM 16.

If the voice coil is energized with the magnetic disk 12 rotating, the head actuator 14 pivots, whereupon each magnetic head 33 is moved to and positioned on a desired track of the disk 12. As this is done, the head 33 is moved radially relative to the disk 12 between the inner and outer peripheral edges of the disk.

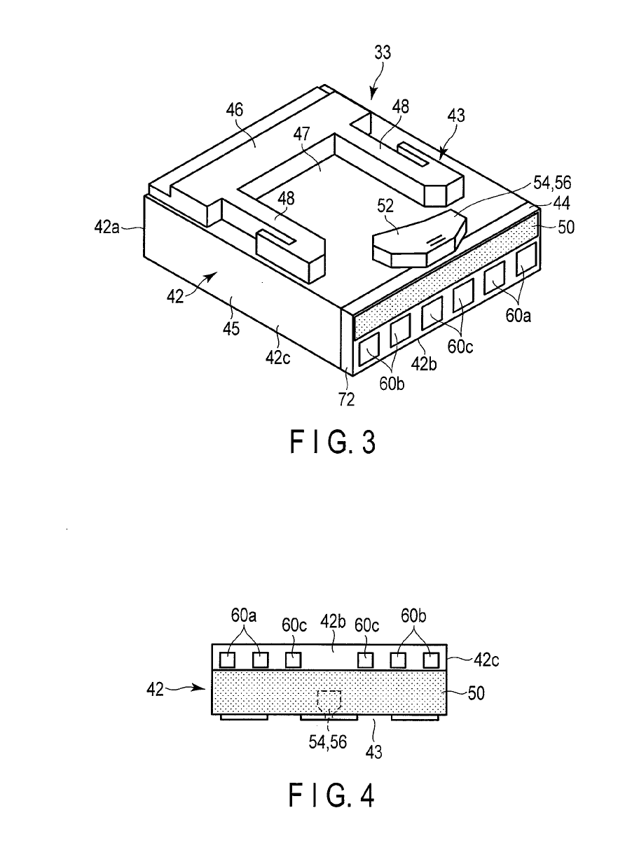

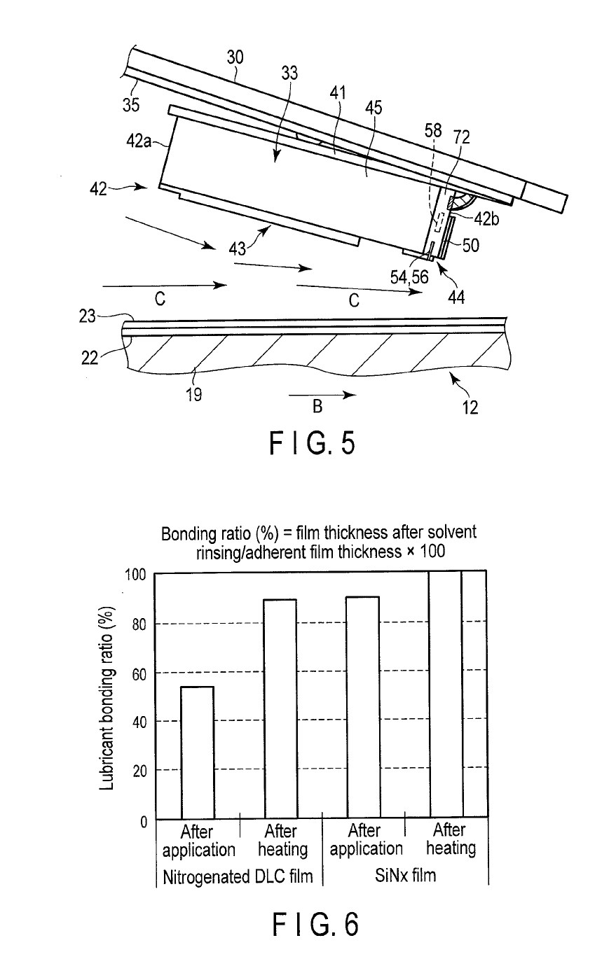

The following is a detailed description of a configuration of each magnetic head 33. FIG. 3 is a perspective view showing the head slider of the magnetic head, FIG. 4 is a front view showing an outflow end surface of the slider, and FIG. 5 is an enlarged side view showing the head.

As shown in FIGS. 2 to 5, the magnetic head 33 is constructed as a flying head and comprises the head slider 42. The head slider 42 comprises a slider body 45, formed of, for example, a sintered body (AlTic or Al₂O₃-Tic) containing alumina and titanium carbide, and the head section 44 formed of a thin film on the outflow end of the slider body. The head slider 42, which is substantially cuboid as a whole, comprises a substantially rectangular disk-facing surface or air-bearing surface (ABS) 43, inflow end surface 42a, outflow end surface 42b, and a pair of side surfaces 42c. The ABS 43 is configured to face the magnetic disk 12. The inflow and outflow end surfaces 42a and 42b individually extend at right angles to the ABS 43. The side surfaces 42c individually extend at right angles to the ABS between the end surfaces 42a and 42b.

The head slider 42 is caused to fly off the disk surface by airflow C (FIGS. 2 and 5) that is produced between the disk surface and the ABS 43 as the magnetic disk 12 rotates. The direction of airflow C is coincident with the direction of rotation B of the disk 12. The head slider 42 is disposed on the surface of the disk 12 in such a manner that the longitudinal direction of the ABS 43 is substantially coincident with the direction of airflow C.

As shown in FIG. 3, a substantially rectangular leading step 46 and a pair of side steps 48, which are configured to produce a positive pressure, protrude from the ABS 43 of the head slider 42. The side steps 48 extend individually along the long sides of the ABS 43 and face each other across a space. The side steps 48 extend from the leading step 46 to the outflow end side of the head slider 42. The leading step 46 and side steps 48 are arranged symmetrically with respect to the central axis of the head slider 42 and form a substantially U-shaped structure as a whole, closed on the inflow side and open on the outflow side.

A negative-pressure cavity 47, which is a recess defined by the side steps 48 and leading step 46, is formed in a substantially central part of the ABS 43. The cavity 47 is formed on the outflow end side of the leading step 46 with respect to the direction of airflow C and opens toward the outflow end. By means of the negative-pressure cavity 47, a negative pressure can be produced at the central part of the ABS 43 at every feasible yaw angle for the HDD.

The head slider 42 comprises a substantially rectangular trailing step 52 that projects at the outflow end portion of the ABS 43 with respect to the direction of airflow C. The trailing step 52 is located downstream relative to the negative-pressure cavity 47 with respect to the direction of airflow C and substantially in the center with respect to the width of the ABS 43.

As shown in FIGS. 3 to 5, the head section 44 comprises a read element 54, write element 56, a plurality of metal films, and heater 58. The read and write elements 54 and 56 are formed on the outflow end surfaces of the slider body 45 by thin-film processing. The metal films constitute conductors. The heater 58 serves to heat and thermally expand a part of the head section, thereby causing the head section to project toward the magnetic disk surface. A protective insulating film 72 of alumina (Al₂O₃) or the like is formed covering the read and write elements 54 and 56 and heater 58 in order to protect and insulate these elements. The protective insulating film 72 defines the contour of the head section 44. Further, the head section 44 comprises a plurality (e.g., three pairs) of terminals 60a, 60b and 60c that are exposed in its end surface, that is, the outflow end surface 42b of the head slider 42. For example, the pair of terminals 60a are electrically connected to the read element 54, the terminals 60b to the write element 56, and the terminals 60c to the heater 58.

As shown in FIG. 5, the head slider 42 is mounted on the conveyor 30 in such a manner that its rear surface is affixed to the gimbal spring 41. The terminals 60a to 60c of the head section 44 are connected to their corresponding conductors of the relay FPC 35 by means of a connection material such as solder.

As described before, the head section 44 of a nonmagnetic insulating material, such as Al₂O₃, which includes the read and write elements 54 and 56, is provided at the outflow end portion of the head slider 42, and constitutes the outflow end surface 42b of the head slider. As shown in FIGS. 3 to 5, an SiNx film 50 is formed on the outflow end surface 42b. The SiNx film 50 is formed ranging from the end edge of the outflow end surface 42b on the side of the ABS 43 to the vicinity of the terminals 60a to 60c and throughout the transverse width of the outflow end surface.

When the VCM 16 is activated, according to the HDD constructed in this manner, the head actuator 14 pivots, whereupon each magnetic head 33 is moved to and positioned on a desired track of the magnetic disk 12. Further, the magnetic head 33 is caused to fly by airflow C that is produced between the disk surface and the ABS 43 as the disk 12 rotates. When the HDD is operating, the ABS 43 of the head slider 42 is opposed to the disk surface with a gap therebetween. As shown in FIGS. 2 and 5, the magnetic head 33 is caused to fly in an inclined posture such that the head section 44 is located closest to the surface of the disk 12. In this state, the read element 54 reads recorded data from the disk 12, while the write element 56 writes data to the disk.

The SiNx film 50 formed on the outflow end surface 42b of the head slider 42 can fully cover the surface of an underlayer even though it is a very thin, fine film. Further, the SiNx film 50 has properties such that it is compatible with the molecules of the lubricant 23 on the surface of the magnetic disk 12 and is resistant (or less susceptible) to heat. FIG. 6 comparatively shows the respective lubricant bond strengths (bonding ratios) of the SiNx film 50 and another film nitrogenated DLC film). The nitrogenated DLC film shown in FIG. 6 is a conventional disk protective film, the lubricant bond strength of which is higher than that of the alumina film that includes the magnetic head elements. As seen from FIG. 6, the lubricant bond strength of the SiNx film 50 is much higher than that of the other film. The SiNx film 50, which is a very thin film, is formed in as wide a range as possible on the alumina film that forms the outflow end surface 42b of the head slider 42. Accordingly, the lubricant transferred to the ABS 43 of the head slider 42 and led to the outflow end surface 42b by airflow C diffuses onto the SiNx film 50, and is bonded to and maintained on the SiNx film for a long period of time. Thus, the lubricant having reached the outflow end surface 42b can be prevented from dropping onto the surface of the magnetic disk 12 or diffusing and returning to the respective ABS-side ends of the read and write elements.

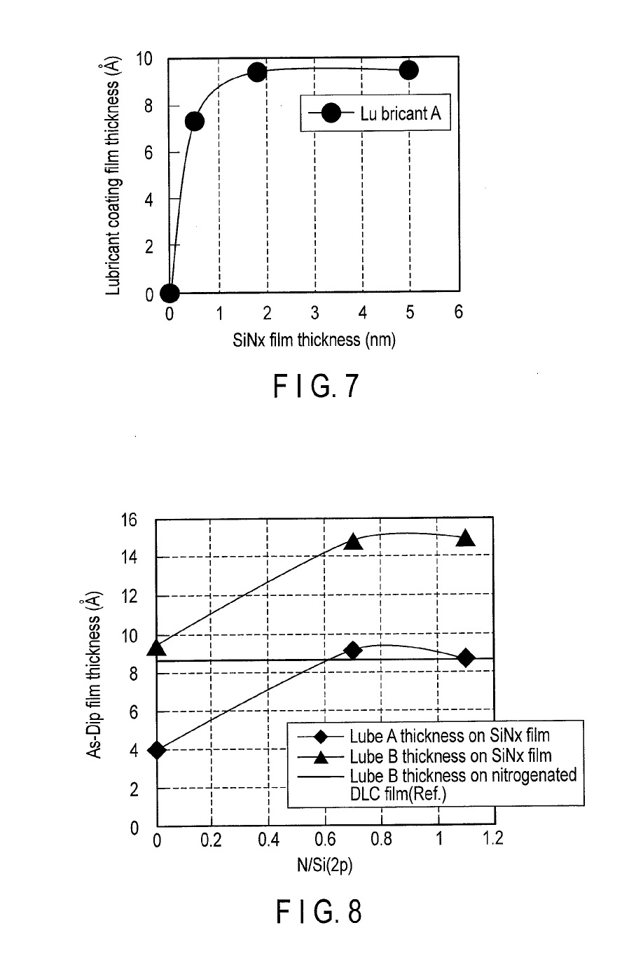

As shown in FIG. 7, the SiNx film 50 can provide a sufficient adherent lubricant film thickness (retention capacity) only if it covers the outflow end surface 42b to a thickness of 0.5 to 1 nm. Thus, the SiNx film 50 of 0.5 to 1 nm thickness can satisfactorily perform the function to retain the transferred lubricant. Although there is no problem if the SiNx film 50 is thicker than 1 nm, it should preferably be 1 nm or less thick.

If the ratio between nitrogen and silicon that constitute the SiNx film 50 is 0.7 or more, in terms of the nitrogen-to silicon ratio between the intensity of Nls and Si2p peaks based on the X-ray photoelectron spectroscopy (XPS) shown in FIG. 8, the SiNx film 50 can provide a sufficient adherent lubricant film thickness or retention capacity.

The SiNx film 50 is formed by the same patterning and film deposition techniques that are used in forming the read and write elements on parts of the alumina film other than those parts through which the terminals 60a to 60c are exposed during a wafer process in which the head section 44 including the read and write elements is formed.

In this case, the very thin SiNx film 50 is exposed on the side of the ABS 43 of the machined head slider 42. Since the SiNx film 50 is 1 nm or less thick, however, the retention of the lubricant attributable to its exposure on the ABS side hardly has an adverse effect. Therefore, this configuration is preferable for simplification of the patterning shape of the SiNx film 50 formed on the alumina film.

According to the magnetic head 33 and the HDD mounted with the magnetic head constructed in this manner, the lubricant transferred from the magnetic disk and accumulated on the outflow end surface 42b of the head slider 42 is firmly retained on the SiNx film 50. In this way, the lubricant transferred from the head slider to the disk can be kept from dropping, so that a read or write failure attributable to the dropped lubricant can be prevented. Accordingly, stable read and write performance can be maintained for a long time. Thus, the magnetic head and HDD obtained are improved in operational reliability.

The following is a description of magnetic heads of HDDs according to alternative embodiments. In the description of these alternative embodiments to follow, like reference numbers are used to designate the same parts as those of the first embodiment, and a detailed description thereof is omitted. The following is a detailed description focused on different parts.

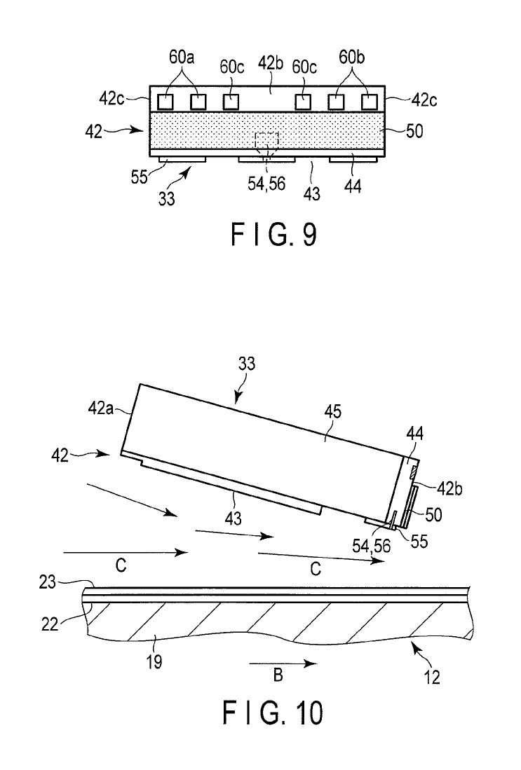

FIGS. 9 and 10 show a magnetic head of an HDD according to a second embodiment. According to the second embodiment, as shown in these drawings, an SiNx film 50 is formed on an outflow end surface 42b of a head slider 42 with a small gap 55 from an end edge on the side of an ABS 43. A head section 44 of alumina, including a read element 54 and write element 56, is only expected to control a pattern shape that forms the SiNx film 50 such that the SiNx film is not exposed on the ABS side during a wafer process for patterning.

According to this arrangement, the influence of the SiNx film 50 on the ABS 43 of the head slider 42 can be entirely removed. In this case, the SiNx film 50, which is formed on the outflow end surface 42b of the head slider 42, is not exposed on the ABS side, so that it is allowed to be thicker than 1 nm.

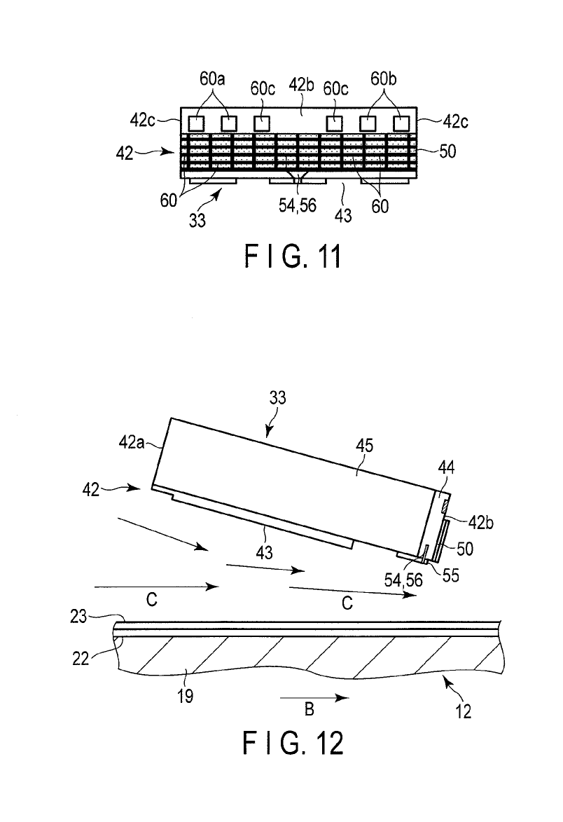

FIGS. 11 and 12 show a magnetic head of an HDD according to a third embodiment. According to the third embodiment, as shown in these drawings, depressions or grooves 60 are formed on the surface of an SiNx film 50, which is formed on an outflow end surface 42b of a head slider 42, such that their depth is less than the thickness of the SiNx film. The shallow depressions or grooves 60 are formed, for example, in a lattice covering the entire surface of the SiNx film 50.

According to the arrangement described above, lumps of a lubricant transferred onto the SiNx film 50 are easily dispersed to a uniform thickness over a wide area of the SiNx film by an effect of the depressions or grooves 60, so that the transferred lubricant retention effect of the SiNx film can be accelerated.

In the second and third embodiments described above, other configurations of the HDD and magnetic head are the same as those of the first embodiment.

In the first to third embodiments, the RF sputtering, RF-CVD, or ECR sputtering method, in which a film with desired lubricant retention properties can be formed, may be suitably selected for forming the SiNx film 50. Further, the depressions or grooves 60 may be formed on the surface of the SiNx film 50 by a suitable method, such as patterning based on dry etching, capable of forming depressions or grooves with a depth less than the SiNx film thickness

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the materials, shapes, sizes, etc., of the constituent elements of the head section may be changed if necessary. In the magnetic disk drive, moreover, the numbers of magnetic disks and heads can be increased as required, and the disk size can be variously selected.

What is claimed is:

1. A magnetic head comprising:
a head slider comprising a disk-facing surface, and an inflow end surface and an outflow end surface extending across the disk-facing surface;
a write element and a read element in an end portion of the head slider on the side of the outflow end surface; and
a SiNx film on the outflow end surface.

2. The magnetic head of claim 1, wherein the SiNx film is on the outflow end surface and comprises a gap from an end edge on a side of the disk-facing surface.

3. The magnetic head of claim 2, further comprising, on a surface of the SiNx film, one of a groove and a depression comprising a depth less than a thickness of the SiNx film .

4. The magnetic head of claim 3, wherein the thickness of the SiNx film ranges from 0.5 to 1 nm.

5. The magnetic head of claim 4, wherein the nitrogen-to-silicon ratio of the SiNx film is at least 0.7.

6. The magnetic head of claim 1, further comprising, on a surface of the SiNx film, one of a groove and a depression comprising a depth less than the thickness of the SiNx film.

7. The magnetic head of claim 6, wherein the thickness of the SiNx film ranges from 0.5 to 1 nm.

8. The magnetic head of claim 7, wherein the nitrogen-to-silicon ratio of the SiNx film is at least 0.7.

9. A disk drive comprising:
a disk-shaped recording medium comprising a recording layer;
a drive unit configured to rotate the recording medium; and
a magnetic head configured to write data on the recording medium and to read data from the recording medium, the magnetic head comprising:
a head slider comprising a disk-facing surface, and an inflow end surface and an outflow end surface extending across the disk-facing surface;
a write element and a read element in an end portion of the head slider on the side of the outflow end surface; and
a SiNx film on the outflow end surface.

10. The magnetic head of claim 9, wherein the SiNx film is on the outflow end surface and comprises a gap from an end edge on a side of the disk-facing surface.

11. The disk drive of claim 10, further comprising, on a surface of the SiNx film, one of a groove and a depression comprising a depth less than a thickness of the SiNx film.

12. The disk drive of claim 11, wherein the thickness of the SiNx film ranges from 0.5 to 1 nm.

13. The disk drive of claim 12, wherein the nitrogen-to-silicon ratio of the SiNx film is at least 0.7.

14. The disk drive of claim 9, further comprising, on a surface of the SiNx film, one of a groove and a depression comprising a depth less than the thickness of the SiNx film.

15. The disk drive of claim 14, wherein the thickness of the SiNx film ranges from 0.5 to 1 nm.

16. The disk drive of claim 15, wherein the nitrogen-to-silicon ratio of the SiNx film is at least 0.7.
